(19) United States
(12) Patent Application Publication
(10) Pub. No.: US 2026/0178310 A1
(43) Pub. Date: Jun. 25, 2026

(54) PRODUCTION FACILITY

(71) Applicant: FUJI CORPORATION, Chiryu (JP)

(72) Inventors: Takafumi MITSUYA, Nishio-shi (JP); Shigeto OYAMA, Kariya-shi (JP)

(73) Assignee: FUJI CORPORATION, Chiryu (JP)

(21) Appl. No.: 19/126,008

(22) PCT Filed: Dec. 1, 2022
(86) PCT No.: PCT/JP2022/044427

§ 371 Date: Apr. 30, 2025

(51) Int. Cl. G06F 8/65; G06F 8/60; G06F 8/658; G06F 21/10

(52) U.S. Cl. CPC G06F 8/65; G06F 8/60; G06F 8/658; G06F 21/10

(57) ABSTRACT

A production facility includes at least one production line including multiple devices and a line management device, and a facility management device configured to manage information of software to be installed in multiple target devices among the multiple devices and the line management device and configured to allow a user to designate the software to be installed in the target devices based on the information, with which it is possible to appropriately manage the software to be installed in the multiple target devices and to appropriately maintain a state of the software in the multiple target devices.

### TECHNICAL FIELD

The present disclosure relates to a production facility that includes at least one production line including multiple devices and a line management device.

### BACKGROUND ART

Conventionally, there is known an information processing system in which a device such as a printer connected to a client can be used from an information processing server in the same use environment as in a case where the device is used from the client (for example, refer to Patent Literature 1). In the information processing system, when it is detected that a user connects the device to the client and a device driver for the device is not present in the information processing server, a device driver present in the client is transmitted to the information processing server, and the device driver is automatically installed in the information processing server.

### CITATION LIST

### Patent Literature

Patent Literature 1: JP-A-2008-146398

### BRIEF SUMMARY

### Technical Problem

In a production facility that includes multiple devices, a line management device, and the like, it is necessary to install new software in the multiple devices or update software in accordance with a specification change or the like. However, when the software corresponding to a target device of the production facility is automatically installed using a technique described in Patent Literature 1, management of software in the entire production facility is complicated, which may lead to erroneous installation of the software or the like or may make it impossible to appropriately execute update of the software or the like.

Therefore, a main object of the present disclosure is to appropriately manage software to be installed in multiple target devices and to appropriately maintain a state of the software in the multiple target devices in a production facility that includes at least one production line including multiple devices and a line management device.

### Solution to Problem

A production facility of the present disclosure is a production facility includes at least one production line including multiple devices and a line management device, and a facility management device configured to manage information of software to be installed in multiple target devices among the multiple devices and the line management device and configured to allow a user to designate the software to be installed in the target devices based on the information.

In the production facility, the information of the software to be installed in the target devices is managed by the facility management device in a centralized manner, and the user can designate the software to be installed in the target devices in the facility management device based on the information. Accordingly, it is possible to appropriately manage the software to be installed in the multiple target devices and to appropriately maintain a state of the software in the multiple target devices.

### BRIEF DESCRIPTION OF DRAWINGS

FIG. 1 is a schematic configuration diagram showing a production facility of the present disclosure.

FIG. 2 is a diagram showing an installation history list stored by a facility management device provided in the production facility of the present disclosure.

FIG. 3 is a diagram showing a software combination list stored by the facility management device provided in the production facility of the present disclosure.

FIG. 4 is a diagram illustrating a software distribution destination setting screen displayed on a display device of the facility management device provided in the production facility of the present disclosure.

FIG. 5 is a diagram illustrating a distribution software setting screen displayed on the display device of the facility management device provided in the production facility of the present disclosure.

FIG. 6 is a flowchart illustrating a routine executed by the facility management device provided in the production facility of the present disclosure.

FIG. 7 is a flowchart illustrating a routine executed by target devices provided in the production facility of the present disclosure.

### DESCRIPTION OF EMBODIMENTS

Next, an embodiment for carrying out the present disclosure will be described with reference to the drawings.

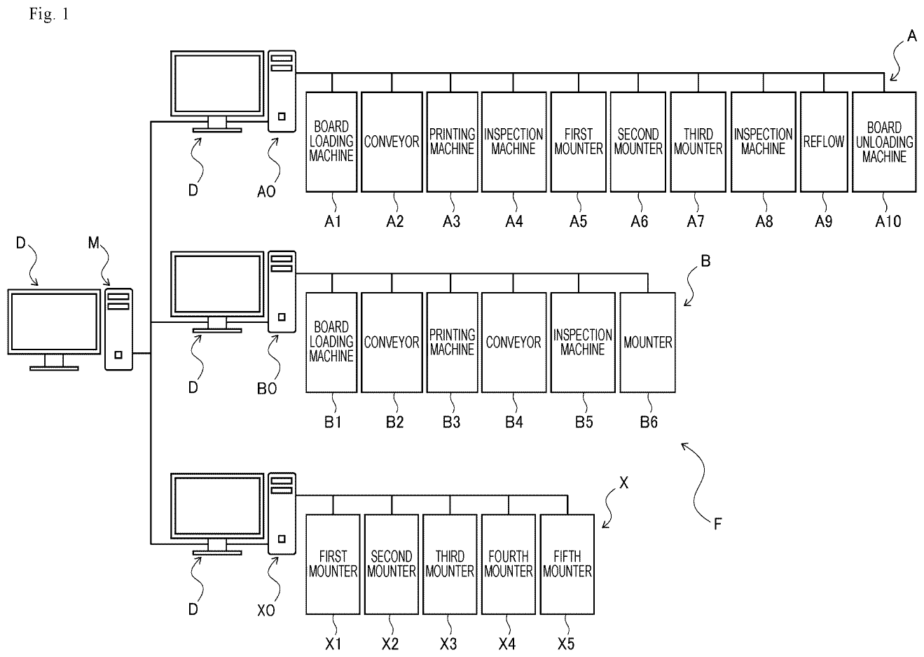

FIG. 1 is a schematic configuration diagram showing production facility F of the present disclosure. Production facility F shown in FIG. 1 includes multiple production lines A, B, . . . , X that produce boards on which components are mounted. Production line A includes multiple devices A1, A2, A3, A4, A5, A6, A7, A8, A9, and A10, and line management device A0 that collectively manages and controls multiple devices A1 to A10.

Device A1 is a board loading machine, and device A2 is a conveyor. Device A3 is a printing machine that prints solder on a wiring pattern of a board, and device A4 is an inspection machine that inspects a state of the solder printed on the board. Device A5 is a first mounter, device A6 is a second mounter, and device A7 is a third mounter. Each of devices A5 to A7 collects a component from a tape fed by a feeder (not shown) and mounts the component on the board. Device A8 is an inspection machine that inspects mounting states of the components mounted by devices A5 to A7 (first to third mounters). Device A9 is a reflow device that melts the solder on the board by heating the board to a reflow temperature set in advance, and device A10 is a board unloading machine.

Line management device A0 of production line A is a computer that includes CPU, ROM, RAM, a storage device that stores various production information and the like related to production of a board, an input/output interface, and the like, and to which an input device such as a keyboard and a mouse (none of which is shown) and display device D are connected. Multiple devices A1 to A10 each include a control device (not shown) including a microcomputer and the like. Line management device A0 gives various command signals and the like to the control devices of multiple devices A1 to A10 in response to requests and the like from multiple devices A1 to A10. The control device of each of devices A1 to A10 exchanges information with line management device A0 to control an operation of device A1 and the like.

Production line B includes multiple devices B1, B2, B3, B4, B5, and B6 and line management device B0 that collectively manages and controls multiple devices B1 to B6. Device B1 is a board loading machine, and device B2 is a conveyor. Device B3 is a printing machine, and device B4 is a conveyor. Further, device B5 is an inspection machine, and device B6 is a mounter. Line management device B0 of production line B is a computer that includes CPU, ROM, RAM, a storage device that stores various production information and the like related to production of a board, an input/output interface, and the like, and to which an input device such as a keyboard and a mouse (none of which is shown) and display device D are connected. Multiple devices B1 to B6 each include a control device (not shown) including a microcomputer and the like. Line management device B0 gives various command signals and the like to the control devices of multiple devices B1 to B6 in response to requests and the like from multiple devices B1 to B6. The control device of each of devices B1 to B6 exchanges information with line management device B0 to control an operation of device B1 and the like.

Production line X includes multiple devices X1, X2, X3, X4, and X5 and line management device X0 that collectively manages and controls multiple devices X1 to X5. Multiple devices X1 to X5 are all mounters. Line management device X0 of production line X is a computer that includes CPU, ROM, RAM, a storage device that stores various production information and the like related to production of a board, an input/output interface, and the like, and to which an input device such as a keyboard and a mouse (none of which is shown) and display device D are connected. Multiple devices X1 to X5 each include a control device (not shown) including a microcomputer and the like. Line management device X0 gives various command signals and the like to the control devices of multiple devices X1 to X5 in response to requests and the like from multiple devices X1 to X5. The control device of each of devices X1 to X5 exchanges information with line management device X0 to control an operation of device X1 and the like.

Further, as shown in FIG. 1, production facility F includes facility management device M that manages information of software to be installed in multiple devices A1 to A10, B1 to B6, and X1 to X5 (respective control devices) and line management device A0, B0, and X0. Facility management device M is a computer that includes CPU, ROM, RAM, a storage device, an input/output interface, and the like, and to which an input device such as a keyboard and a mouse (none of which is shown) and display device D are connected.

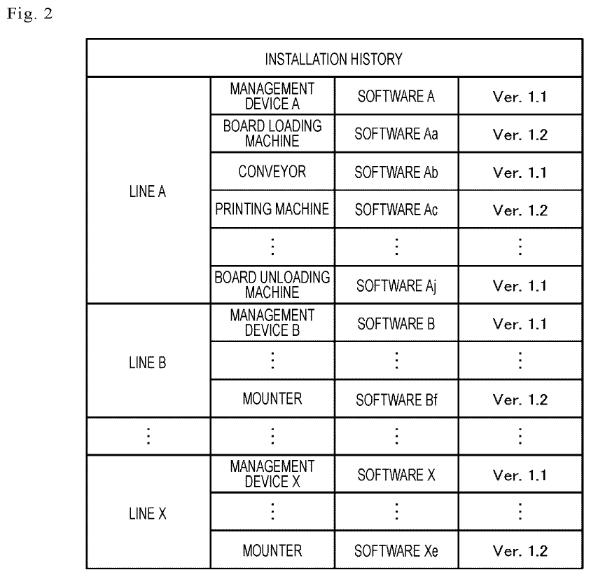

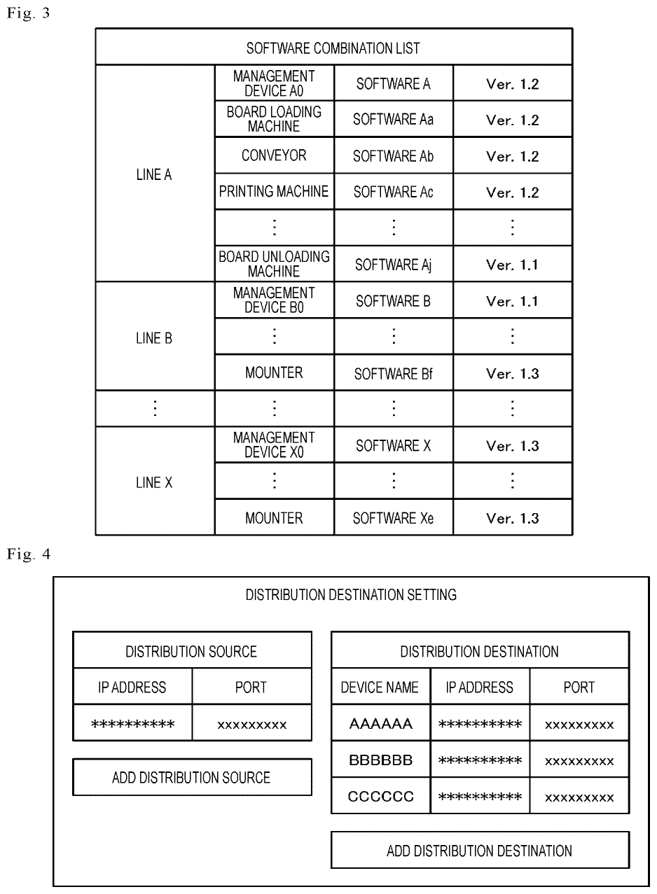

The storage device of facility management device M stores an installation history list shown in FIG. 2 and a software combination list shown in FIG. 3. The installation history list indicates versions of the software installed in the control devices of devices A1 to A10, B1 to B6, and X1 to X5 and line management devices A0, B0, and X0 and the software that has been installed. The installation history list is updated by facility management device M every time new software, version-upgraded software, or the like is installed in any of devices A1 to A10, B1 to B6, and X1 to X5 and line management devices A0, B0, and X0. The software combination list defines software and versions (latest versions) to be installed in devices A1 to A10, B1 to B6, and X1 to X5 and line management devices A0, B0, and X0. The software combination list is updated by a user such as an administrator of production facility F or facility management device M when new software is introduced in accordance with a specification change or the like of production facility F or when a version upgrade or the like of software is performed.

The storage device of facility management device M stores software of the latest version to be installed in devices A1 to A10, B1 to B6, and X1 to X5 and line management devices A0, B0, and X0. Furthermore, facility management device M can exchange data and the like with each of multiple devices A1 to A10, B1 to B6, and X1 to X5 (respective control devices) and each of line management devices A0, B0, and X0 through a dedicated protocol, and transmits software (installation file) to be installed to devices A1 to A10, B1 to B6, and X1 to X5 and line management devices A0, B0, and X0 in response to an instruction from the user. An installation application for installing the software transmitted from facility management device M in the devices (target devices) is installed in advance in the control devices of devices A1 to A10, B1 to B6, and X1 to X5 and line management devices A0, B0, and X0 of production facility F. In the present embodiment, the installation application causes the control devices of the target devices to execute a general-purpose file operation including at least copying, deleting, compressing, and extracting a file, together with executing an executable file.

Further, in production facility F of the present embodiment, the user can designate software to be installed in desired devices (hereinafter referred to as “target devices”) among devices A1 to A10, B1 to B6, and X1 to X5 and line management devices A0, B0, and X0 by using facility management device M. More specifically, by clicking an ADD DISTRIBUTION DESTINATION button on a distribution destination setting screen shown in FIG. 4 displayed on display device D of facility management device M, the user can select device names given in advance to the multiple devices from a pull-down list set based on the software combination list or the like and designate the target devices in which the software is to be installed. When the device names of the target devices are designated, IP addresses of the target devices as distribution destinations of the software and ports of the IP addresses are displayed on display device D.

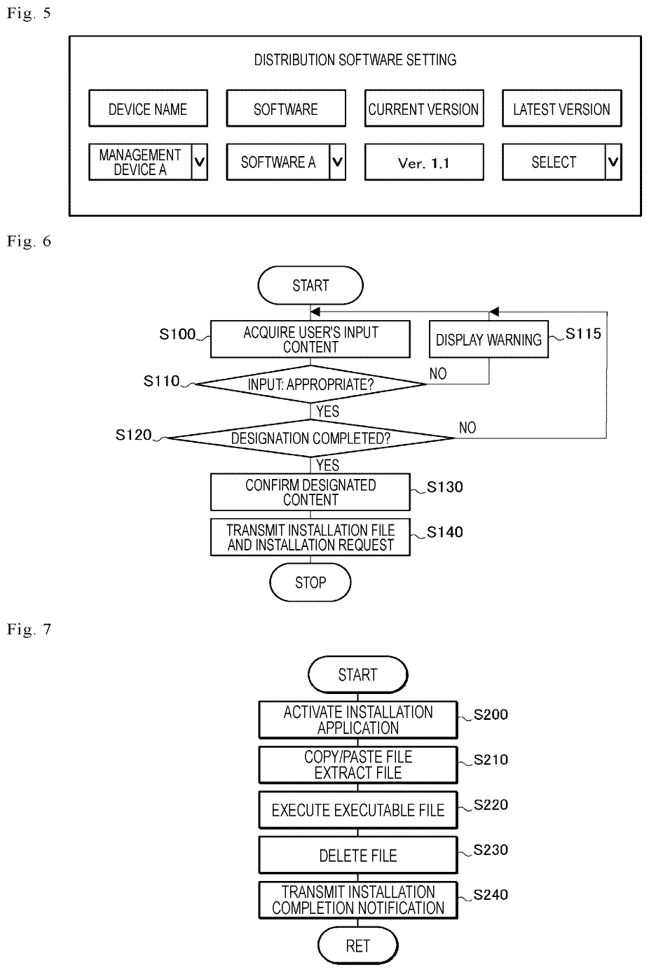

When the software to be installed in the target devices is stored in a server or the like (not shown) other than facility management device M, the user can select the server or the like as a distribution source from a pull-down list by clicking an ADD DISTRIBUTION SOURCE button. Further, when a predetermined operation is executed by the user, a distribution software setting screen shown in FIG. 5 is displayed on display device D. On the distribution software setting screen, the user can select and designate the software to be installed in the target devices and the versions thereof from a pull-down list set based on the software combination list or the like while referring to a software name and a current version displayed on the screen.

FIG. 6 is a flowchart illustrating a routine executed by facility management device M when the software to be installed in the target devices is designated by the user on the distribution software setting screen.

As shown in FIG. 6, when the user designates the software to be installed in the target devices and the versions on the distribution software setting screen, facility management device M acquires the content input by the user (step S100). Further, facility management device M refers to the above-described software combination list to determine (checks) whether the software and the version designated by the user are appropriate according to the software combination list (step S110). When the software and the version designated by the user are not appropriate (step S110: NO), facility management device M displays a predetermined warning on the distribution software setting screen in order to notify the user that there is an error in the designation of the software or the like (step S115), and executes the process of step S100 in accordance with arrival of a next execution timing.

When the software and the version designated by the user or re-designated by the user in accordance with the warning are appropriate (step S110: YES), facility management device M determines whether the designation of the target devices, the software, and the versions by the user is completed (step S120). When the designation of the target devices, the software, and the versions by the user is not completed (step S120: NO), facility management device M executes the processes of step S100 and subsequent steps in accordance with the arrival of the next execution timing. On the other hand, when the designation of the target devices, the software, and the versions by the user is completed (step S120: YES), facility management device M confirms the target devices, the software, and the versions designated by the user (step S130), transmits a compressed file of an installation file (data) of the designated software and an installation request of the software to one or multiple designated target devices (step S140), and ends the routine in FIG. 6.

FIG. 7 is a flowchart illustrating a routine executed by the control devices of the target devices when the installation file and the installation request of the software are transmitted from facility management device M.

As shown in FIG. 7, when the compressed file of the installation file of the software and the installation request are received from facility management device M, the control devices of the target devices activate the above-described installation application (step S200). When the installation application is activated, the control devices of the target devices copy the compressed file of the installation file from facility management device M, paste the compressed file into a folder set in advance, and extract the compressed file (step S210).

Next, the control devices of the target devices execute an executable file in the extracted folder and install the software designated by the user (step S220). After the installation is completed, the control devices of the target devices delete the compressed file, the extracted folder, and the like received from facility management device M (step S230). Further, the control devices of the target devices transmit an installation completion notification indicating that the installation of the designated software is completed to facility management device M (step S240), and end the routine in FIG. 7. When the installation completion notification is received from the target devices, facility management device M updates the installation history list.

As described above, production facility F includes the production lines A, B, . . . , X each having multiple devices A1 to A10, B1 to B6 or X1 to X5 and line management device A0, B0 or X0, and facility management device M that manages the information of the software to be installed in the multiple target devices among multiple devices A1 to A10, B1 to B6, and X1 to X5 (each control device) and line management devices A0, B0 and X0. Then, facility management device M allows the user to designate the software to be installed in the target devices and the version based on the information via display device D.

In production facility F, the information of the software to be installed in the target devices is managed by facility management device M in a centralized manner, and the user can designate the software to be installed in the target devices and the version from the pull-down list set based on the information on display device D of facility management device M. Accordingly, it is possible to appropriately manage the software to be installed in the multiple target devices and to appropriately maintain a state of the software in the multiple target devices.

Facility management device M has a function of checking whether the software designated by the user is to be installed in the target devices (step S110). Accordingly, it is possible to favorably reduce erroneous installation of software in the target devices. In the above embodiment, when there is an error in the designation of software or the like by the user, facility management device M displays a predetermined warning on the distribution software setting screen; however, the configuration is not limited to this. That is, facility management device M may be configured to perform a check based on the above information and set the pull-down list on the distribution software setting screen such that software not to be installed in the target devices is not selectable by the user.

Further, facility management device M stores the software combination list that defines the software to be installed in the target devices, and checks, based on the software combination list, whether the software designated by the user is to be installed in the target devices (step S110). Accordingly, it is possible to appropriately check whether the software designated by the user is to be installed in the target devices by using facility management device M. Meanwhile, the process of step S110 may be a process of checking whether software designated by the user is to be installed in the target devices based on a list created in advance to define software not to be installed in the target devices.

In production facility F, in the control devices of multiple devices A1 to A10, B1 to B6, and X1 to X5 that are target devices, the installation application for installing the software in the devices is installed in advance. The target devices acquire the software transmitted from facility management device M, another server, or the like, and execute the installation application to install the software. Accordingly, it is not necessary for the user to install software corresponding to each of multiple devices (target devices) A1 to A10, B1 to B6, and X1 to X5, and thus it is possible to significantly reduce a management load of software in production facility F. However, production lines A, B, . . . , X may include a device controlled by line management device A0 or the like without including the control device in which software is installed.

Furthermore, the installation application causes the target devices to execute a general-purpose file operation including at least copying, deleting, compressing, and extracting a file, together with executing an executable file. As a result, a transfer time of a file (software) can be shortened, and an unnecessary file remaining in the target devices can be favorably suppressed. In addition, when new software is installed in the target devices and a setting file of the software is converted into an external file, it is possible to overwrite a separately created setting file using the copy/paste function or the like of the installation application. Further, when the software installed in the target devices has a log output function, it is possible to create a compressed file for log collection using the copy/paste function, the compression/extraction function, or the like of the installation application, and transmit the compressed file from the target devices to line management device A0 or the like.

The present disclosure is by no means limited to the above embodiment, and it goes without saying that various changes can be made within the scope of the extension of the present disclosure. Further, the above embodiment is merely one specific aspect of the present disclosure, and does not limit the elements of the present disclosure.

### INDUSTRIAL APPLICABILITY

The present disclosure can be used in a production facility that includes at least one production line including multiple devices and a line management device.

### REFERENCE SIGNS LIST

A0, B0, X0: line management device, A1, A2, A3, A4, A5, A6, A7, A8, A9, A10, B1, B2, B3, B4, B5, B6, X1, X2, X3, X4, X5: device (target device), D: display device, F: production facility, M: facility management device.

1. A production facility comprising:
at least one production line including multiple devices and a line management device; and
a facility management device configured to manage information of software to be installed in multiple target devices among the multiple devices and the line management device and configured to allow a user to designate the software to be installed in the target devices based on the information.

2. The production facility according to claim 1, wherein the facility management device is configured to check whether the software designated by the user is to be installed in the target devices.

3. The production facility according to claim 2, wherein the facility management device has a list that defines the software to be installed in the target devices or the software not to be installed in the target devices, and is configured to check, based on the list, whether the software designated by the user is to be installed in the target devices.

4. The production facility according to claim 1,
wherein an installation application for installing the software in the target devices is installed in the target devices in advance, and
the target devices are configured to acquire the software from the facility management device or another device and configured to execute the installation application to install the software.

5. The production facility according to claim 4, wherein the installation application is configured to cause the target devices to execute a general-purpose file operation including at least copying, deleting, compressing, and extracting a file, together with executing an executable file.
